(19) United States
(12) Patent Application Publication
(10) Pub. No.: US 2025/0365377 A1
(43) Pub. Date: Nov. 27, 2025

(54) MEDIUM TRANSPORT DEVICE AND IMAGE READING DEVICE

(71) Applicant: SEIKO EPSON CORPORATION, TOKYO (JP)

(72) Inventor: Ryoichi SHUTO, Kitakyushu-shi (JP)

(21) Appl. No.: 19/214,133

(22) Filed: May 21, 2025

(30) Foreign Application Priority Data
May 21, 2024 (JP) 2024-082604

(51) Int. Cl. H04N 1/00

(52) U.S. Cl. CPC H04N 1/00615; H04N 1/00602; H04N 1/0062; H04N 1/00647

(57) ABSTRACT

A medium transport device 4 includes a feeding section 7 having a first feed port 61 configured to feed a first medium 21 into the housing 5 at an upper section of a housing and a transport section 9 configured to transport the first medium in the transport direction F, wherein the feeding section includes a support section 13, which extends upward from the first feed port, and has a support surface 12 configured to support the first medium to be fed to the first feed port. a small width medium feeding section 27 configured to feed a second medium 22 having a smaller width dimension than the first medium 21, and the small width medium feeding section 27 is disposed at the first feed port 61 and includes a second feed port 28 configured to feed the second medium 22 into the housing and guide sections 31 and 32 configured to guide width direction edge sections 29 and 30 of the second medium.

The present application is based on, and claims priority from JP Application Serial Number 2024-082604, filed May 21, 2024, the disclosure of which is hereby incorporated by reference herein in its entirety.

### BACKGROUND

### 1. Technical Field

The present disclosure relates to a medium transport device and an image reading device.

### 2. Related Art

An example of the related art of this type of device is disclosed in JP-A 2021-1037. JP-A-2021-1037 discloses an image reading device that has two receipt insertion ports for feeding receipts of different width sizes.

When an elongated receipt is set to the receipt insertion port, the receipt buckles or falls forward, resulting in an unstable posture during setup or the receipt being skewed when transported. In the case where the image reading device has a U-turn path, there is a possibility that the receipt discharged through the U-turn path is bent or buckling and drawn into the receipt insertion port again, or falls down at the forward. That is, there is a problem that the posture of the receipt is unstable when it is transported, and it is difficult to handle the receipt.

In the related art, there is no description considering this problem, and it can be said that there is room for improvement in this respect.

### SUMMARY

To overcome the above problem, a medium transport device according to the present disclosure includes a feeding section having a first feed port at an upper section of a housing, the first feed port being for feeding a first medium into the housing and a transport section configured to transport the first medium fed from the feeding section in a transport direction along a transport path, wherein the feeding section has a support section, which extends upward from the first feed port, and includes a support surface configured to supports the medium to be fed to the first feed port, a small width medium feeding section configured to feed a second medium having a smaller width dimension than the first medium, and the small width medium feeding section is disposed at the first feed port and includes a second feed port configured to feed the second medium into the housing and a guide section configured to guide a width direction edge portion of the second medium.

Another medium transport device according to the present disclosure includes a feeding section having a feed port at an upper section of a housing, the feed port being for feeding a medium into the housing; a transport section configured to transport the medium fed from the feeding section in a transport direction along a transport path; and a discharge section having a discharge port configured to discharge the medium transported by the transport section to outside of the housing, wherein the feeding section includes a support section that extends upward from the feed port and that has a support surface configured to support the medium to be fed to the feed port, the transport path includes a straight path extending from the feed port from an upper portion to a lower portion of the housing, and a U-turn path existing from a downstream end of the straight path in the transport direction toward the discharge port disposed above, the discharge port is disposed below the feed port of the housing, the discharge section has a placement surface that is an outer surface of the housing, that extends from the discharge port side toward the feed port, and onto which the medium discharged from the discharge port is placed, a medium pressing section that is provided in the discharge port and that restricts posture of the medium transported through the U-turn path and discharged from the discharge port, and the medium pressing section includes a base section positioned on the discharge port side and a posture restriction section that extends from the base section to a position above the feed port along the support surface.

Another medium transport device according to the present disclosure includes a feeding section having a first feed port at an upper section of a housing, the first feed port being for feeding a first medium into the housing; a transport section configured to transport the first medium fed from the feeding section in a transport direction along a transport path; and a discharge section having a discharge port configured to discharge the first medium transported in the transport direction to the outside of the housing, wherein the feeding section includes a support section that extends upward from the first feed port and that includes a support surface configured to support the first medium to be fed to the first feed port, the transport path includes a straight path extending from the first feed port from an upper portion to a lower portion of the housing, and a U-turn path existing from a downstream end of the straight path in the transport direction toward the discharge port disposed upward, the discharge port is disposed below the first feed port of the housing, the discharge section has a placement surface that is an outer surface of the housing, that extends from the discharge port side toward the first feed port, and onto which the first medium discharged from the discharge port is placed, a small width medium feeding section configured to feed a second medium having a smaller width dimension than the first medium, the small width medium feeding section is disposed at the first feed port and includes a second feed port configured to feed the second medium into the housing and a guide section configured to guide a width direction edge portion of the second medium, a medium pressing section that is provided in the discharge port and that restricts the posture of the second medium transported through the U-turn path and discharged from the discharge port, and the medium pressing section includes a base section positioned on the discharge port side and a posture restriction section that extends from the base section to a position above the first feed port along the support surface.

An image reading device according to the present disclosure includes the medium transport device according to any one of the first to third aspects (to be described later) and a reading section configured to read an image of the first medium or the second medium.

### BRIEF DESCRIPTION OF THE DRAWINGS

FIG. 1 is a perspective view corresponding to a medium transport device and an image reading device of a first embodiment and a third embodiment.

FIG. 2 is a side view corresponding to the medium transport device and the image reading device of the first embodiment and the third embodiment.

FIG. 3 is a perspective view corresponding to the medium transport device and the image reading device of the first embodiment.

FIG. 4 is a side cross-sectional view corresponding to the medium transport device and the image reading device of the first embodiment.

FIG. 5 is a perspective view of a main part of a portion of the small width medium feeding section of the first embodiment and the third embodiment.

FIG. 6 is a side cross-sectional view of the main part of a portion of the small width medium feeding section of the first embodiment and the third embodiment.

FIG. 7 is a perspective view of the small width medium feeding section of the first embodiment and the third embodiment.

FIG. 8 is a rear view of the small width medium feeding section of the first embodiment and the third embodiment.

FIG. 9 is a rear view of a main part of the main part of a portion of the small width medium feeding section of the first embodiment and the third embodiment.

FIG. 10 is a perspective view of the main part of a portion of the small width medium feeding section showing a modification of the first embodiment.

FIG. 11 is a perspective view of a medium pressing section of the third embodiment.

FIG. 12 is a side cross-sectional view of a main portion of the medium pressing section of the third embodiment.

FIG. 13 is a front view showing a state in which the medium pressing section of the third embodiment is retracted.

FIG. 14 is a perspective view corresponding to a medium transport device and an image reading device of a second embodiment.

### DESCRIPTION OF EMBODIMENTS

Hereinafter, the present disclosure will be schematically described.

To overcome the above problem, a medium transport device according to a first aspect of the present disclosure includes a feeding section having a first feed port at an upper section of a housing, the first feed port being for feeding a first medium into the housing and a transport section configured to transport the first medium fed from the feeding section in a transport direction along a transport path, wherein the feeding section includes a support section extending upward from the first feed port, and has a support surface configured to support the first medium to be fed to the first feed port, a small width medium feeding section configured to feed a second medium having a smaller width dimension than the first medium, the small width medium feeding section includes a second feed port that is disposed at the first feed port and that is configured to feed the second medium into the housing and a guide section configured to guide a width direction edge portion of the second medium.

According to the present aspect, the feeding section includes the support section that extends upward from the first feed port, and has the support surface configured to support the first medium to be fed to the first feed port. It includes the small width medium feeding section configured to feed the second medium having a smaller width dimension than the first medium. The small width medium feeding section is disposed at the first feed port and includes the second feed port for feeding the second medium into the housing and the guide section configured to guide the width direction edge portion of the second medium.

This makes it possible, even if the second medium is, for example, small in width and relatively elongated, such as a receipt, it is possible to pass the front edge portion of the second medium through the second feed port of the small width medium feeding section and set the second medium with a portion of the second medium supported on the support surface of the support section. By this, the posture of the second medium when it is set is stabilized and, that is, the settability is improved. Further, since the second medium is fed to the transport path following the guide section, skew can be suppressed.

A medium transport device according to a second aspect of the disclosure includes a feeding section having a feed port at an upper section of a housing, the feed port being for feeding a medium into the housing; a transport section configured to transport the medium fed from the feeding section in a transport direction along a transport path; and a discharge section having a discharge port configured to discharge the medium transported by the transport section to outside of the housing, wherein the feeding section includes a support section that extends upward from the feed port and that has a support surface configured to support the medium to be fed to the feed port, the transport path includes a straight path extending from the feed port from an upper portion to a lower portion of the housing, and a U-turn path existing from a downstream end of the straight path in the transport direction toward the discharge port disposed above, the discharge port is disposed below the feed port of the housing, the discharge section has a placement surface that is an outer surface of the housing, that extends from the discharge port side toward the feed port, and onto which the medium discharged from the discharge port is placed, a medium pressing section that is provided in the discharge port and that restricts posture of the medium transported through the U-turn path and discharged from the discharge port, and the medium pressing section includes a base section positioned on the discharge port side and a posture restriction section that extends from the base section to a position above the feed port along the support surface.

In the configuration in which the transport path has the U-turn path, for example, when a relatively elongated medium is discharged from the discharge port, there is a concern that the medium may bend or buckle and fall down forward, or be drawn into the feed port again.

According to the present aspect, the medium pressing section is provided in the discharge port and restricts the posture of the medium transported through the U-turn path and discharged from the discharge port. The medium pressing section includes a base section positioned on the discharge port side and a posture restriction section extends from the base section to a position above the feed port along the support surface.

By this, since the posture of the medium discharged from the discharge port is restricted in a state along the support surface, the posture of the medium is stabilized without buckling or the like. As a whole, the stackability of the medium is improved.

A medium transport device according to a third aspect of the disclosure includes a feeding section having a first feed port at an upper section of a housing, the first feed port being for feeding a first medium into the housing; a transport section configured to transport the first medium fed from the feeding section in a transport direction along a transport path; and a discharge section having a discharge port configured to discharge the first medium transported in the transport direction to the outside of the housing, wherein the feeding section includes a support section that extends upward from the first feed port and that includes a support surface configured to support the first medium to be fed to the first feed port, the transport path includes a straight path extending from the first feed port from an upper portion to a lower portion of the housing, and a U-turn path existing from a downstream end of the straight path in the transport direction toward the discharge port disposed upward, the discharge port is disposed below the first feed port of the housing, the discharge section has a placement surface that is an outer surface of the housing, that extends from the discharge port side toward the first feed port, and onto which the first medium discharged from the discharge port is placed, a small width medium feeding section configured to feed a second medium having a smaller width dimension than the first medium, the small width medium feeding section includes a second feed port that is disposed at the first feed port and that is configured to feed the second medium into the housing and a guide section configured to guide a width direction edge portion of the second medium, a medium pressing section that is provided in the discharge port and that restricts the posture of the second medium transported through the U-turn path and discharged from the discharge port, and the medium pressing section includes a base section positioned on the discharge port side and a posture restriction section that extends from the base section to a position above the first feed port along the support surface.

(1) According to the present aspect, the feeding section includes the support section, which extends upward from the first feed port, and has the support surface configured to support the medium to be fed to the first feed port. It includes the small width medium feeding section configured to feed the second medium having a smaller width dimension than the first medium. The small width medium feeding section is disposed at the first feed port and includes the second feed port for feeding the second medium into the housing and the guide section configured to guide the width direction edge portion of the second medium.

This makes it possible, even if the second medium is, for example, small in width and relatively elongated, such as a receipt, it is possible to pass the front edge portion of the second medium through the second feed port of the small width medium feeding section and set the second medium with a portion of the second medium supported on the support surface of the support section. By this, the posture of the second medium when it is set is stabilized and, that is, the settability is improved. Further, since the second medium is fed to the transport path following the guide section, skew can be suppressed.

(2) In the configuration in which the transport path has the U-turn path, for example, when a relatively elongated second medium is discharged from the discharge port, there is a concern that the second medium may be bent or buckling and fall down at the forward, or drawn into the first feed port again.

According to the present aspect, the medium pressing section is provided in the discharge port and restricts the posture of the second medium transported through the U-turn path and discharged from the discharge port. The medium pressing section includes the base section positioned on the discharge port side and a posture restriction section that extends from the base section to a position above the first feed port along the support surface. By this, since the posture of the second medium discharged from the discharge port is restricted in a state along the support surface, the posture of the second medium is stabilized without buckling or the like. As a whole, the stackability of the second medium is improved.

(3) According to the present aspect, when the second medium set in the small width medium feeding section is discharged from the discharge port, its posture is further restricted by the medium pressing section. By this, the posture of the second medium is stabilized without buckling or the like. As a whole, the settability and the stackability of the second medium are improved.

The medium transport device according to a fourth aspect of the present disclosure is an aspect according to the first aspect or the third aspect, wherein the small width medium feeding section includes a third feed port configured to feed into the housing a third medium narrower than the width dimension of the second medium in the transport direction and a guide section configured to guide a width direction edge portion of the third medium.

According to the present aspect, the small width medium feeding section further includes the third feed port configured to feed the third medium smaller than the width dimension in the transport direction of the second medium, and the guide section for guiding the width direction edge portion of the third medium. By this, the settability and the stackability are improved with respect to mediums having different width dimensions.

The medium transport device according to a fifth aspect of the present disclosure is an aspect according to the first aspect or the third aspect, wherein the small width medium feeding section includes a curl correction section configured to correct a curl of the second medium to be fed.

Note that the present aspect can also be according to the fourth aspect.

Here, “correct a curl of the second medium to be fed” in “includes a curl correction section configured to correct a curl of the second medium to be fed” means that when the second medium is set in the second feed port of the small width medium feeding section in a curled state rather than flat, the curl correction section functions to change the curled state in a direction closer to a flat state.

According to the present aspect, the small width medium feeding section includes the curl correction section configured to correct the curl of the second medium to be fed. By this, when the second medium is set to the second feed port of the small width medium feeding section in a curled state, the curl is corrected by the curl correction section. By this, the transport to the transport section is smoothly performed, and the transport failure can be suppressed.

The medium transport device according to a sixth aspect of the present disclosure is an aspect according to the fifth aspect, wherein the small width medium feeding section is positioned upstream of and adjacent to a feed roller pair in the transport direction, the curl correction section includes a projection section that contacts a width direction central portion of a first surface of the second medium, the small width medium feeding section includes a base surface positioned on the second surface side, which is an opposite side than the first surface of the second medium, the base surface includes two extension sections that extend in the transport direction at both end portions in the width direction of the second medium, the two extension sections are positioned to outside in an axial direction of the feed roller pair, and a tip end of each of the two extension sections partially overlaps with the feed roller pair in the transport direction, and guides a front edge of the second medium toward a nip position of the feed roller pair.

According to the present aspect, the curl correction section includes a projection section that contacts a width direction central portion of a first surface of the second medium. The small width medium feeding section includes the base surface positioned on the second surface side of the second medium. The base surface includes two extension sections that extend in the transport direction at both end portions in the width direction of the second medium. The two extension sections are positioned to the outside in the axial direction of the feed roller pair. The tip end of each of the two extension sections partially overlaps with the feed roller pair in the transport direction, and guides a front edge of the second medium toward a nip position of the feed roller pair.

By this, even in a state where the second medium is curled, the first surface is pressed toward the base surface by the projection section by setting it in the second feed port of the small width medium feeding section, and thus it is possible to easily correct the curl.

Since the front edge of the second medium is guided toward the nip position of the feed roller pair in a state where the curl is corrected, the second medium can be fed out toward the transport section more smoothly, and transport failures can be further suppressed.

The medium transport device according to a seventh aspect of the present disclosure is an aspect according to the third aspect, wherein the small width medium feeding section has a first attachment section configured to attach to and detach from the housing, the first attachment section has a plate-shaped clip section configured to sandwich an upper edge section of the first feed port and the placement surface, and a portion of the clip section that is in contact with the placement surface extends from an upper edge section to a lower edge section of the placement surface.

Note that the present aspect can also be according to any one of the fourth aspect to the sixth aspect.

According to the present aspect, since the small width medium feeding section has the first attachment section configured to attach to and detach from the housing, it can be easily attached to and detached from the housing. That is, the small width medium feeding section can be attached when necessary, and can be detached when not necessary.

Since the first attachment section has the plate-shaped clip section configured to sandwich the upper edge section of the first feed port from the placement surface side and the rear surface side of the placement surface, it can be reliably attached to the housing.

Since a portion of the clip section that is in contact with the placement surface extends from an upper edge section to a lower edge section of the placement surface, it is possible to reduce the likelihood that the second medium discharged from the discharge port will catch on the clip section.

The medium transport device according to an eighth aspect of the present disclosure is an aspect according to the seventh aspect, wherein the small width medium feeding section is positioned and attached to the housing by a first positioning mechanism.

According to the present aspect, the small width medium feeding section is positioned and attached on the housing by the first positioning mechanism. By this, it is possible to prevent the position at which the small width medium feeding section is attached from varying.

The medium transport device according to a ninth aspect of the present disclosure is an aspect according to the second aspect or the third aspect, wherein a first angle formed by a surface on which the medium pressing section extends and a horizontal surface is smaller than a second angle formed by the support surface and the horizontal surface.

According to the present aspect, the first angle formed by the surface on which the medium pressing section extends and the horizontal surface is smaller than the second angle formed by the support surface and the horizontal surface. That is, the distance between the medium pressing section and the support surface of the support section gradually narrows upward. By this, it is possible to reliably support the second medium to be fed and the second medium to be discharged from the discharge port, and it is possible to suppress the drawing the second medium into the first feed port, the occurrence of buckling, or the like.

The medium transport device according to a tenth aspect of the present disclosure is an aspect according to the second aspect or the third aspect, wherein a surface of the medium pressing section that faces the support surface has a rib that protrudes toward the support surface.

Note that the present aspect can also be according to the ninth embodiment.

According to the present aspect, the surface of the medium pressing section that faces the support surface has a rib that protrudes toward the support surface. By this, since the second medium to be fed and the second medium to be discharged are restricted to the support surface side by the rib, it is possible to further suppress the that the second medium is drawn into the first feed port, the occurrence of buckling, or the like.

The medium transport device according to an eleventh aspect of the present disclosure is an aspect according to the second aspect or the third aspect, wherein the medium pressing section is retractable in a direction away from the first feed port.

Note that the present aspect can also be according to the ninth aspect or the tenth aspect.

According to the present aspect, the medium pressing section is retractable in a direction away from the first feed port. By this, by retracting the medium pressing section from the first feed port, it is possible to easily set the first medium in the first feed port or set the second medium in the small width medium feeding section.

The medium transport device according to a twelfth aspect of the present disclosure is an aspect according to the second aspect or the third aspect, wherein the medium pressing section has a second attachment section configured to attach to and detach from the housing and the second attachment section has a locking section configured to lock to a locked section provided at a section of the discharge port of the housing.

Note that the present aspect can also be according to any one of the ninth aspect to the eleventh aspect.

According to the present aspect, since the medium pressing section has the second attachment section configured to attach to and detach from the housing, it can be easily attached to and detached from the housing. That is, the medium pressing section can be attached when necessary and detached when not necessary.

Since the second attachment section has the locking section configured to lock to the locked section provided at the section of the discharge port of the housing, the attachment and detachment can be realized with a simple structure.

The medium transport device according to a thirteenth aspect of the present disclosure is an aspect according to the twelfth aspect, wherein the medium pressing section is attached on the housing by a second positioning mechanism.

According to the present aspect, the medium pressing section is attached on the housing by the second positioning mechanism. By this, it is possible to prevent the position at which the medium pressing section is attached from varying.

An image reading device according to a fourteenth aspect of the present disclosure includes the medium transport device according to any one of the first aspect to the third aspect and

a reading section configured to read an image of the first medium or the second medium.

According to the present aspect, as an image reading device such as a scanner, it is possible to obtain the effect achieved in the medium transport device of any one of the first aspect to the third aspect.

### EMBODIMENTS

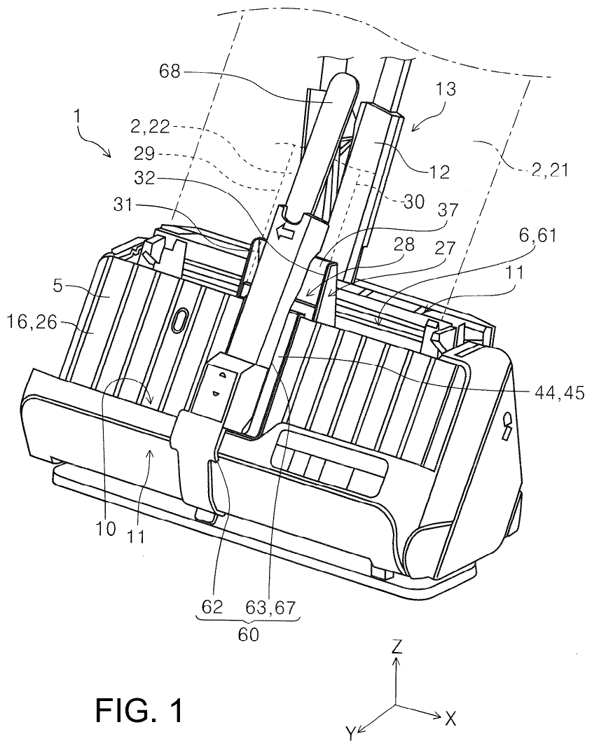

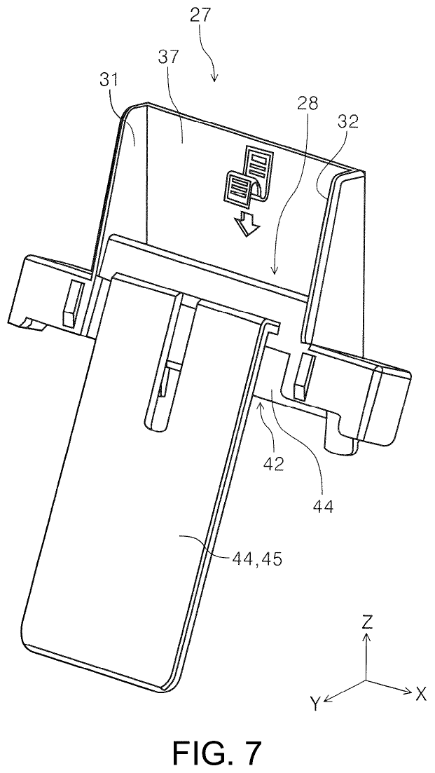

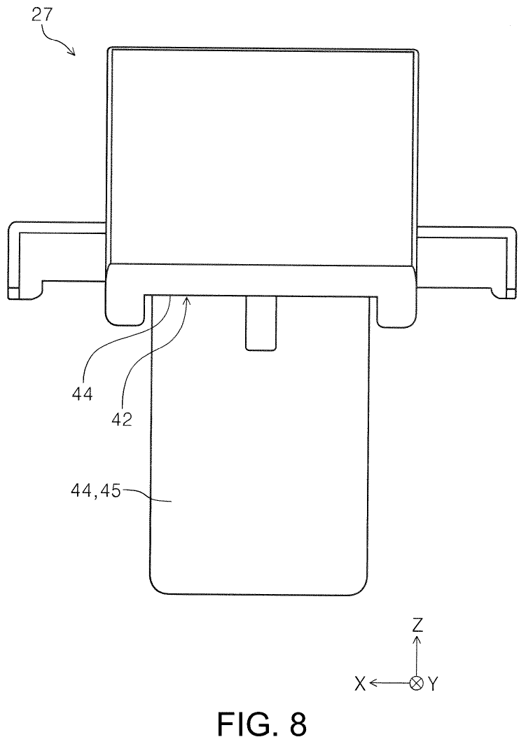

Hereinafter, a medium transport device according to an embodiment of the present disclosure and an image reading device including the medium transport device will be specifically described based on FIG. 1 to FIG. 14.

In the following description, three axes orthogonal to each other are referred to as an X-axis, a Y-axis, and a Z-axis, respectively, as shown in each drawing. The direction indicated by the arrows of the three axes (X, Y, and Z) is the + direction of each direction, and the opposite direction is the − direction. The Z-axis direction corresponds to a vertical direction, that is, a direction in which gravity acts, a +Z direction indicates a vertically upward direction, and a −Z direction indicates a vertically downward direction. The X-axis direction and the Y-axis direction correspond to horizontal directions. The +Y direction indicates the direction to the front of the device and the −Y direction indicates the direction to the rear of the device. The +X direction indicates the direction to the right of the device and the −X direction indicates the direction to the left of the device.

### General Description of Image Reading Device and Medium Transport Device

The image reading device of the present embodiment is a scanner capable of reading an image of a medium. Here, the term “image” refers to something that is visually recorded on the medium, such as characters, figures, tables, drawings, photographs, or the like. The medium is not limited to sheets, but also includes cards, booklets, or the like.

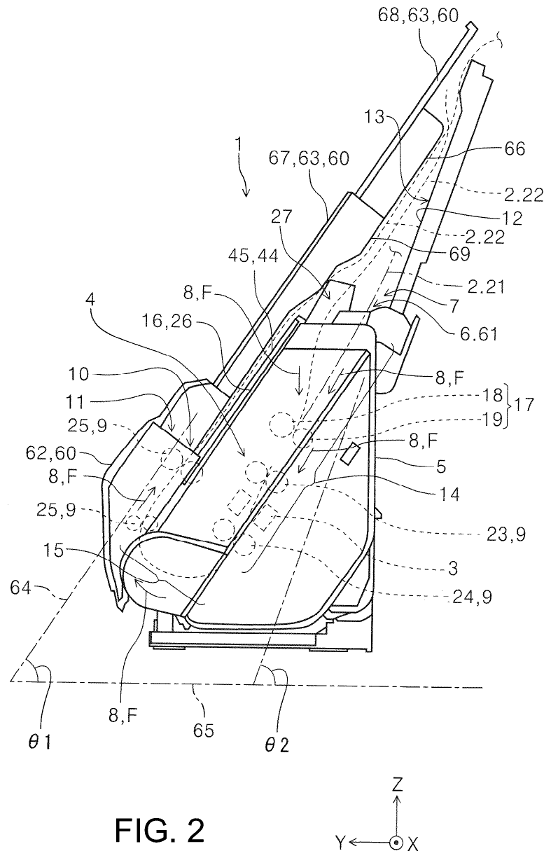

As shown in FIG. 1 and FIG. 2, an image reading device 1 includes a reading section 3 (for example, a Contact Image Sensor Module (CISM), FIG. 2) capable of reading the image of a medium 2 and a medium transport device 4.

The medium transport device 4 includes a feeding section 7 having a first feed port 61, which is a feed port 6 for feeding a first medium 21 (one dot chain line), which is the medium 2, into a housing 5 that forms the exterior of the image reading device 1 at the upper section of the housing 5. Further, as indicated by dashed line in FIG. 2, the medium transport device 4 includes a transport section 9 that transports the medium 2 fed from the feeding section 7 in a transport direction F along a transport path 8 and a discharge section 11 that has a discharge port 10 through which the medium 2 transported by the transport section 9 is discharged to outside the housing 5.

The feeding section 7 includes a support section 13, which extends upward from the feed port 6, and has a support surface 12 that supports the medium 2 to be fed to the feed port 6. The transport path 8 includes a straight path 14 extending straight from the feed port 6 from the upper section (+Z) to the lower section (−Z) of the housing 5, and a U-turn path 15, which is an inversion path existing from the downstream end of the straight path 14 in the transport direction F toward the discharge port 10 disposed above. The discharge port 10 is disposed below the feed port 6 of the housing 5. The discharge section 11 is an outer surface of the housing 5, extends from discharge port 10 side toward feed port 6, and has a placement surface 16 for placing the medium 2 discharged from the discharge port 10.

As shown in FIG. 2, the feeding section 7 includes a feed roller pair 17 inside the housing 5. The feed roller pair 17 includes a feed roller 18 and a separation roller 19 to which power is transmitted from a drive source (not shown). The medium 2 set in the feeding section 7 and supported by the support section 13 is fed to the transport path 8 one by one by the feed roller pair 17.

The medium 2 fed to the transport path 8 is transported in the transport direction F on the transport path 8 by receiving a transport force from a first transport roller pair 23 constituting the transport section 9 disposed along the straight path 14, passes through the reading region of the reading section 3, and is further transported by receiving a transport force from a second transport roller pair 24. Further, the transport direction F is inversed in the U-turn path 15. Then, by two discharge roller pairs 25 forming the transport section 9 positioned at an end point of the transport path 8, the medium 2 is left out of the transport path 8, is discharged from the discharge port 10 to a discharge receiving section 26, and is placed on the placement surface 16.

The first transport roller pair 23, the second transport roller pair 24, and the discharge roller pair 25 to which power is transmitted from a drive source (not shown). Each operation of the feed roller pair 17, the first transport roller pair 23, the reading section 3, the second transport roller pair 24, and the discharge roller pair 25 is performed by a control signal from a control section (not shown).

### First Embodiment

### Small Width Medium Feeding Section

The medium transport device 4 according to a first embodiment will be described below with reference to FIG. 1 to FIG. 10.

As shown in FIG. 1 to FIG. 3, the medium transport device 4 according to the present first embodiment includes the feeding section 7 having the first feed port 61, the transport section 9 that transports the first medium 21 in the transport direction F along the transport path 8, and the support section 13 having the support surface 12 that supports the first medium 21 to be fed to the first feed port 61.

In the present first embodiment, the medium transport device 4 further includes a small width medium feeding section 27 for feeding a second medium 22 (dashed line) having a width dimension smaller than that of the first medium 21. The small width medium feeding section 27 is disposed at the first feed port 61. The small width medium feeding section 27 includes a second feed port 28 for feeding the second medium 22 into the housing 5 and guide sections 31 and 32 for guiding width direction edge portions 29 and 30 of the second medium 22.

A receipt and the like with a width of 60 mm or 80 mm is an example of the second medium 22, which has a small width dimension. Many of these receipts are elongated and the problems of the present disclosure are likely to arise in the case of this type of medium.

### Curl Correction Section

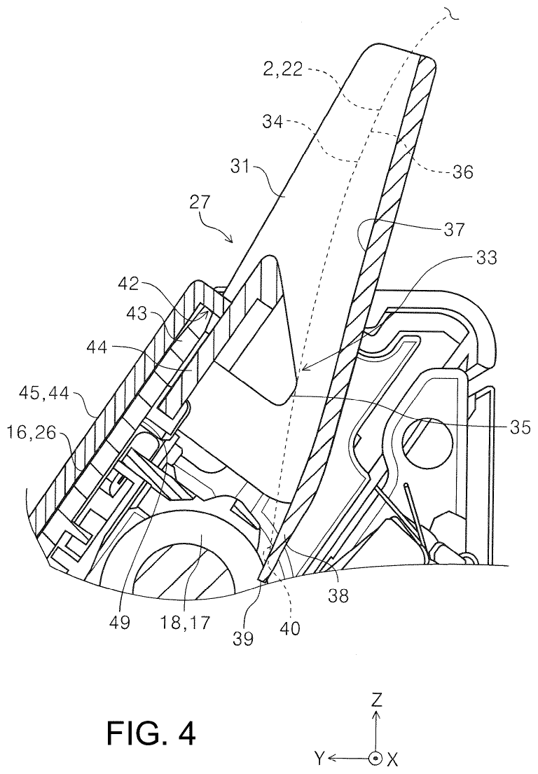

As shown in FIG. 4 to FIG. 6, in the present embodiment, the small width medium feeding section 27 includes a curl correction section 33 that corrects a curl of the second medium 22 to be fed.

Here, “corrects a curl of the second medium 22 to be fed” in “includes a curl correction section 33 that corrects a curl of the second medium 22 to be fed” means that when the second medium 22 is set in the second feed port 28 of the small width medium feeding section 27 in a curled state rather than flat, the curl correction section 33 functions to change the curled state of the second medium in a direction closer to a flat state.

### Curl Correction at Three Points

The small width medium feeding section 27 is positioned adjacent to the upstream side of the feed roller pair 17 in the transport direction F.

The curl correction section 33 includes a projection section 35 that contacts a width direction (X-axis direction) central portion of a first surface 34 of the second medium 22. The small width medium feeding section 27 includes a base surface 37 positioned on a second surface 36 side, which is the opposite side of the second medium 22 than the first surface 34.

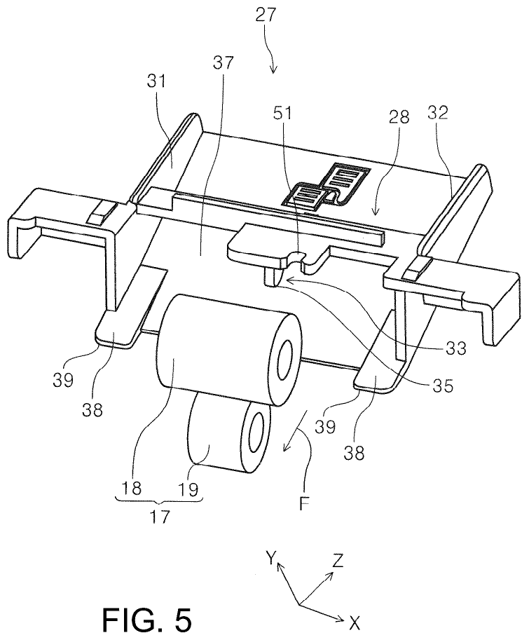

As shown in FIG. 5, the base surface 37 is provided with two extension sections 38 and 38 extending in the transport direction F at both edge portions in the width direction (X-axis direction) of the second medium 22. The two extension sections 38 and 38 are positioned outside in the axial direction (X-axis direction) of the feed roller pair 17. Note that FIG. 5 is described with a portion thereof omitted so that the projection section 35 inside the small width medium feeding section 27 can be seen.

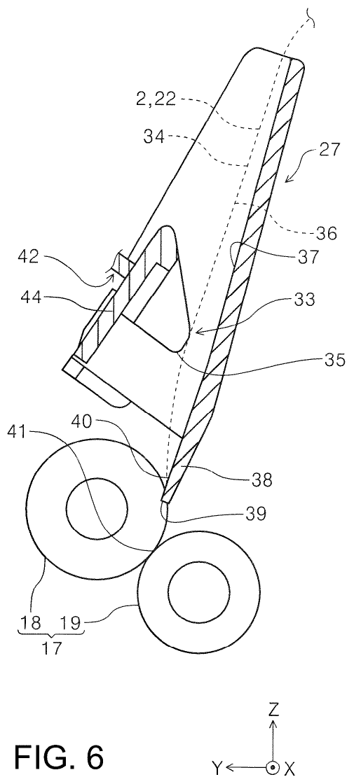

As shown in FIG. 6, tip ends 39 and 39 of the two extension sections 38 and 38 partially overlap with the feed roller pair 17 in the transport direction F. This overlap is configured to guide a front edge 40 of the second medium 22 toward the a nip position 41 of the feed roller pair 17.

As shown in FIG. 5 and FIG. 6, when the front edge 40 of the second medium 22 is set through the second feed port 28 of the small width medium feeding section 27, the following state is obtained.

The front edge 40 of the second medium 22 is in a state where the second surfaces 36 at both edge portions in the width direction (X-axis direction) are supported by the two extension sections 38 near the nip position 41 of the feed roller pair 17. Further, the first surface of the second medium 22 is pushed toward the base surface 37 by the projection section 35 at a position upstream of the two extension sections 38 and 38.

That is, the second medium 22 is in a state of being pressed from both the first surface 34 side and the second surface 36 side at three points of the projection section 35 and the two extension sections 38 and 38, and the curl is corrected. At the same time, the front edge 40 of the second medium 22 is in a state of moving toward the nip position 41 of the feed roller pair 17.

Positioning Mechanism and Mechanism that Enables Attachment and Detachment of Small Width Medium Feeding Section

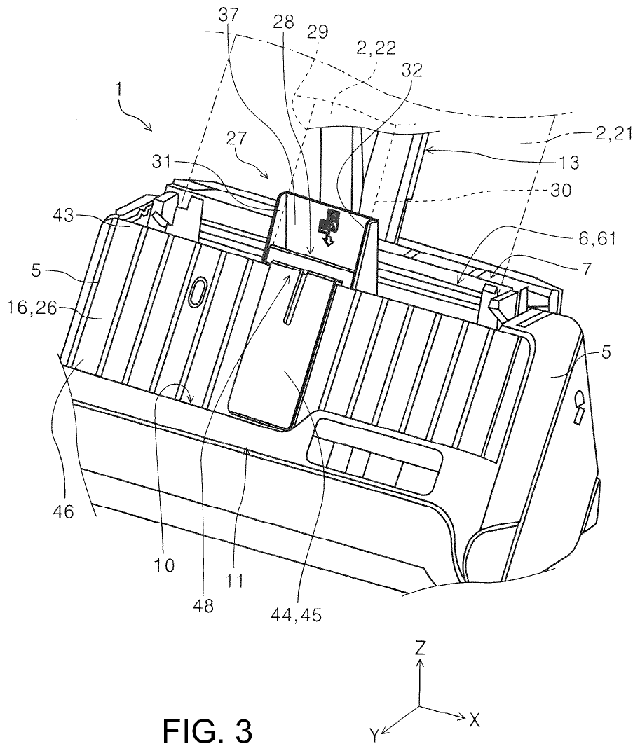

As shown in FIG. 3 and FIG. 7 to FIG. 9, in the present embodiment, the small width medium feeding section 27 has a first attachment section 42, which is attachable to and detachable from the housing 5. The first attachment section 42 has a plate-like clip section 44 for sandwiching an upper edge section 43 (FIG. 4) of the first feed port 61 from the placement surface 16 side and from a rear surface 49 side of the placement surface 16.

A portion 45 of the clip section 44 that contacts the placement surface 16 is configured to extend from the upper edge section 43 to the lower edge section 46 of the placement surface 16. As shown in FIG. 3, the extending length of the portion 45 in contact with the placement surface 16 is formed so as to reach the vicinity of the discharge port 10 of the discharge section 11.

Note that the small width medium feeding section 27 may be fixed to the housing 5 instead of being attachable to and detachable from the housing 5.

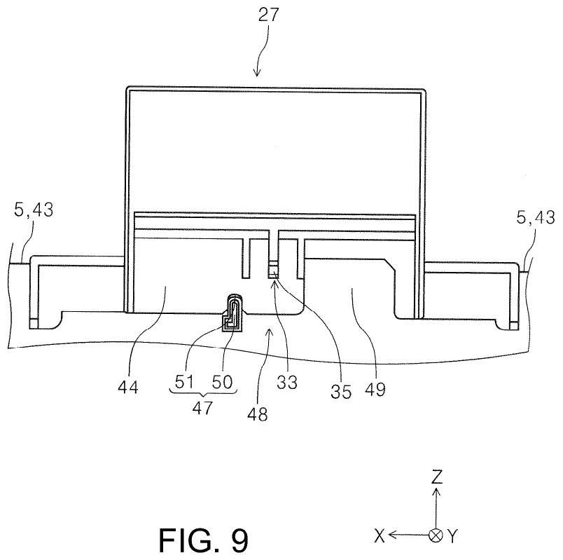

As shown in FIG. 9, in the present embodiment, the small width medium feeding section 27 is configured to be positioned in the housing 5 by a first positioning mechanism 47 and to be attached at a first attached position 48. Note that FIG. 9 is described with a portion thereof omitted so that the first positioning mechanism 47 inside the small width medium feeding section 27 can be seen.

The first attached position 48 is the width direction (X-axis direction) central portion of the first feed port 61 and is a position corresponding to the position of the feed roller pair 17.

The first positioning mechanism 47 is composed of a protrusion section 50 that is provided on the rear surface 49 of the placement surface 16 of the first feed port 61 and a recess section 51 that is formed in the small width medium feeding section 27. The small width medium feeding section 27 is positioned by being attached so that the protrusion section 50 and the recess section 51 are fitted and attached at the first attached position 48.

### Setting of Second Medium in Small Width Medium Feeding Section

As shown in FIG. 3, in a state where the small width medium feeding section 27 is attached to the first feed port 61 of the housing 5, the front edge 40 side of the second medium 22, such as a receipt, is passed through the second feed port 28 and set. A rear edge side of the second medium 22 is supported by the support surface 12 of the support section 13.

Subsequently, the feed roller pair 17 is driven to feed out the second medium 22 toward the transport section 9. The second medium 22 is transported in the transport direction F by the transport section 9, passes through the reading section 3, and is discharged outside from the discharge port 10 of the discharge section 11.

### Description of Effects of First Embodiment

(1) In the present embodiment, the feeding section 7 includes the support section 13, which extends upward from the first feed port 61, and has the support surface 12 configured to support the first medium 21 to be fed to the first feed port 61. It includes the small width medium feeding section 27 configured to feed the second medium 22, which has a smaller width dimension than the first medium 21. The small width medium feeding section 27 is disposed at the first feed port 61 and includes the second feed port 28 for feeding the second medium 22 into the housing 5 and guide sections 31 and 32 configured to guide the width direction edge portions 29 and 30 of the second medium 22.

By this, even if the second medium 22 is a medium that has a small width and that is relatively elongated, such as a receipt, it is possible to pass the front edge portion 40 of the second medium 22 through the second feed port 28 of the small width medium feeding section 27 and set it with a portion of the second medium 22 supported on the support surface 12 of the support section 13. By this, the posture of the second medium 22 when it is set is stabilized and, that is, the settability is improved. Furthermore, since the second medium 22 is fed to the transport path 8 following the guide sections 31 and 32, skew can be suppressed.

(2) In the present embodiment, the small width medium feeding section 27 includes the curl correction section 33 configured to correct the curl of the second medium 22 to be fed. By this, when the second medium 22 is set to the second feed port 28 of the small width medium feeding section 27 in a curled state, the curl is corrected by the curl correction section 33. By this, feed out toward the transport section 9 is smoothly performed, and the transport failure can be suppressed.

(3) In the present embodiment, the curl correction section 33 includes the projection section 35 in contact with the width direction central portion of the first surface 34 of the second medium 22. The small width medium feeding section 27 includes the base surface 37 positioned on the second surface 36 side of the second medium 22. The base surface 37 is provided with the two extension sections 38 and 38 extending in the transport direction F at both edge portions in the width direction (X-axis direction) of the second medium 22. The two extension sections 38 and 38 are positioned outside in the axial direction (X-axis direction) of the feed roller pair 17. The tip ends 39 and 39 of the two extension sections 38 and 38 partially overlap with the feed roller pair 17 in the transport direction F, and guide the front edge 40 of the second medium 22 toward the nip position 41 of the feed roller pair 17.

By this, even in a state where the second medium 22 is curled, by setting it in the second feed port 28 of the small width medium feeding section 27, the first surface 34 is pressed toward the base surface 37 by the projection section 35, and thus it is possible to easily correct the curl.

Since the front edge 40 of the second medium 22 is guided toward the nip position 41 of the feed roller pair 17 in a state where the curl is corrected, the second medium 22 can be fed out toward the transport section 9 more smoothly, and transport failures can be further suppressed.

(4) In this embodiment, since the small width medium feeding section 27 has the first attachment section 42, which is attachable to and detachable from the housing 5, it can be easily attached to and detached from the housing 5. That is, the small width medium feeding section 27 can be attached when necessary, and can be detached when not necessary.

Since the first attachment section 42 has the plate-like clip section 44 for sandwiching the upper edge section 43 of the first feed port 61 from the placement surface 16 side and the rear surface 49 side of the placement surface 16, the first attachment section 42 can be reliably attached to the housing 5.

Since the portion 45 of the clip section 44 that is in contact with the placement surface 16 extends from the upper edge section 43 to a lower edge section 46 of the placement surface 16, it is possible to reduce the likelihood that the second medium 22 discharged from the discharge port 10 will catch on the clip section 44.

(5) In the present embodiment, the small width medium feeding section 27 is positioned and attached to the housing 5 by the first positioning mechanism 47. By this, it is possible to prevent the position at which the small width medium feeding section 27 is attached from varying.

### Modified Example of First Embodiment

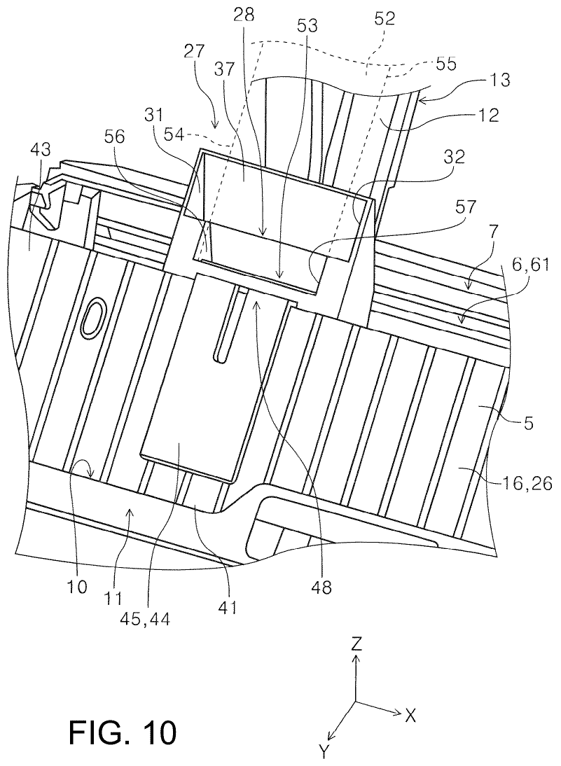

Based on FIG. 10, a modified example of the embodiment 1 will be described.

In the present modified example, the small width medium feeding section 27 includes a third feed port 53 in addition to the second feed port 28. The third feed port 53 is configured to feed, into the housing 5, a third medium 52 that has a width dimension in the transport direction F that is smaller than that of the second medium 22. The small width medium feeding section 27 further includes guide sections 56 and 57 that guide width direction edge portions 54 and 55 of the third medium 52. The third feed port 53 has basically the same structure as the second feed port 28 and differs in that the dimension in the width direction is smaller.

Similar to the second medium 22, the third medium 52 that passed through the third feed port 53 has its curl corrected by the projection section 35 and the two extension sections 38 and 38, and is guided toward the feed roller pair 17.

In the present modification, the small width medium feeding section 27 further includes the third feed port 53 configured to feed the third medium 52, which has a narrower width dimension in the transport direction F than that of the second medium 22, and includes the guide sections 56 and 57 for guiding the width direction edge portions 54 and 55 of the third medium 52. By this, the settability and the stackability are improved with respect to mediums having different width dimensions.

### Second Embodiment

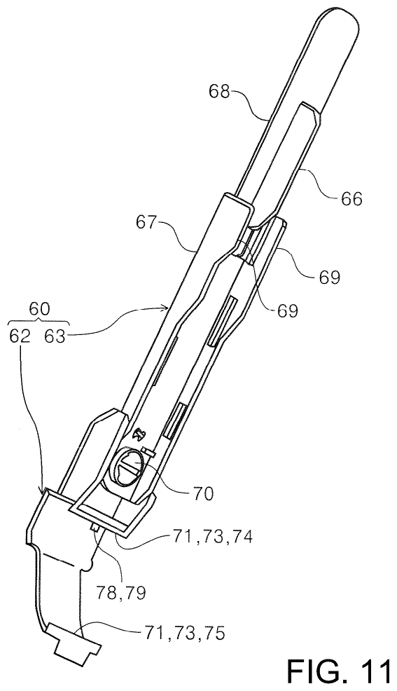

Next, the medium transport device 4 according to a second embodiment and the image reading device 1 including the medium transport device 4 will be described with reference to FIG. 1, FIG. 2, FIG. 4, and FIG. 11 to FIG. 13. The same parts as those in the first embodiment are denoted by the same reference symbols and the description of the configuration and the corresponding effects thereof will be omitted.

The medium transport device 4 of the second embodiment includes the following components in addition to the components of the medium transport device 4 of the first embodiment.

The medium transport device 4 according to the second embodiment further includes a medium pressing section 60. The medium pressing section 60 is provided to the discharge port 10. The medium pressing section 60 is configured to restrict the posture of the second medium 22 that is being transported along the U-turn path 15 and discharged from the discharge port 10.

As shown in FIG. 1 and FIG. 11, the medium pressing section 60 includes a base section 62 positioned on the discharge port 10 side and a posture restriction section 63 extends from the base section 62 to a position above the first feed port 61 along the support surface 12 of the support section 13.

As shown in FIG. 2, in the present embodiment, a first angle θ1 formed by a surface 64 on which the medium pressing section 60 extends and a horizontal surface 65 is smaller than the second angle θ2 formed by the support surface 12 and the horizontal surface 65.

Further, as shown in FIG. 2 and FIG. 11, a rib 66, which protrudes toward the support surface 12, is provided on a surface of the medium pressing section 60, which faces the support surface 12.

In the present embodiment, the posture restriction section 63 includes a base section 67 and an extension section 68 and is configured to be extendible and contractable. When in use, if necessary, the extension section 68 can be pulled out of the base section 67 to increase the overall length. When not in use, the extension section 68 is moved back into the base section 67. Here, the extension section 68 side of the base section 67 is also provided with protruding sections 69 and 69 that protrude in the same manner as the rib 66 and is configured to support the function of the rib 66.

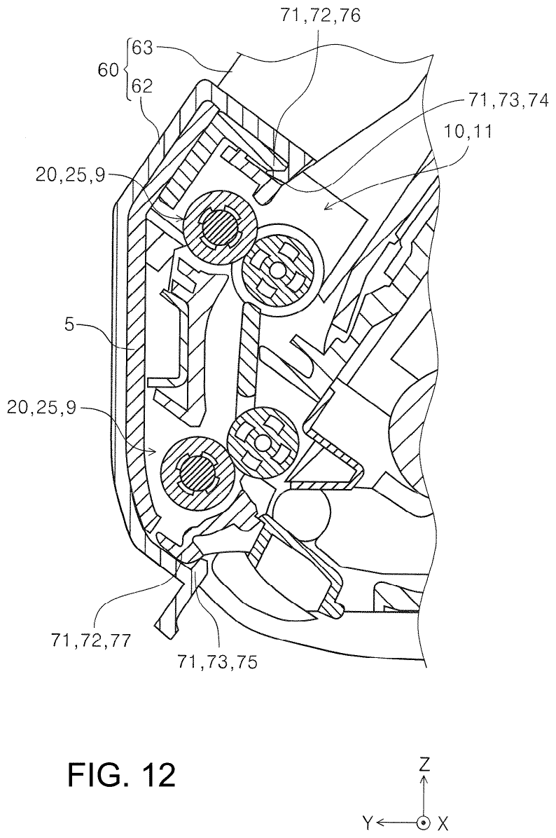

As depicted in FIG. 11 and FIG. 12, in the present embodiment, the medium pressing section 60 has a second attachment section 71 that is attachable and detachable with respect to the housing 5. The second attachment section 71 has a locking section 73 that locks onto a locked section 72 provided on the discharge section 11 of the housing 5.

The locking section 73 has a first locking section 74 positioned on the posture restriction section 63 side of the base section 62 and a second locking section 75 positioned on the opposite side of the base section 62 than the posture restriction section 63. The locked section 72 is provided at the discharge section 11 and has a first locked section 76 with which the first locking section 74 is engaged and a second locked section 77 with which the second locking section 75 is engaged.

FIG. 12 shows a state in which the medium pressing section 60 is attached to the discharge section 11 of the housing 5 by the second attachment section 71. FIG. 11 shows a state in which the medium pressing section 60 is detached from the discharge section 11 of the housing 5.

As shown in FIG. 11, in the present embodiment, the medium pressing section 60 is configured to be positioned and attached to the housing 5 by a second positioning mechanism 78.

The second positioning mechanism 78 has a protrusion section 79 provided at the first locking section 74 of the medium pressing section 60. It is configured so that positioning is performed by fitting the protrusion section 79 into a recess section (not shown) provided on the discharge section 11 side.

The position at which the medium pressing section 60 is positioned by the second positioning mechanism 78 is the same as that of the small width medium feeding section 27. That is, it is a width direction (X-axis direction) central portion of the first feed port 61 and is a position corresponding to the position of the feed roller pair 17.

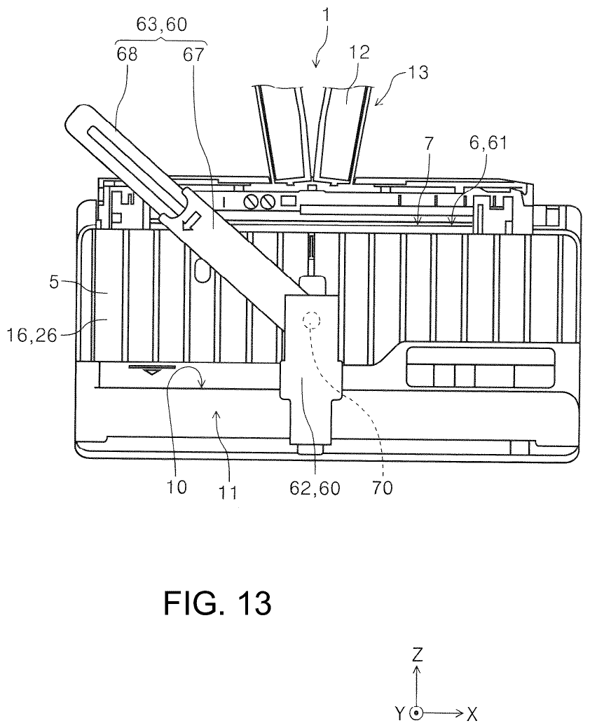

As shown in FIG. 13, in the present embodiment, the medium pressing section 60 is configured to be retractable in a direction away from the first feed port 61. Note that FIG. 13 shows a state in which the small width medium feeding section 27 is detached.

Here, the posture restriction section 63 is pivotably connected to the base section 62 by a pivot fulcrum 70 (FIG. 11). The posture restriction section 63 retracts by being pivoted in the width direction (X-axis direction) along the placement surface 16 of the housing 5. By this retracting, the first feed port 61 side is opened with respect to the front surface, making access easier.

The structure for retracting the posture restriction section 63 is not limited to a specific structure. For example, the posture restriction section 63 may be retracted to the front side (Y-axis direction) of the housing 5, instead of being pivoting in the width direction.

### Restriction of Posture of Second Medium by Medium Pressing Section

As shown in FIG. 2, when the second medium 22 is discharged from the discharge port 10 of the discharge section 11, it is forced to pass through a region between the medium pressing section 60 and the support surface 12 of the support section 13 due to the presence of the medium pressing section 60. By this, even if the second medium 22 undergoes curved deformation due to curling, for example, or has a bent portion, such curved deformation or bending is suppressed, that is, the posture of the second medium 22 is restricted to a substantially flat posture.

### Description of Effects of Second Embodiment

(1) In the present embodiment, the following effects are obtained in addition to the above described effects based on the presence of the small width medium feeding section 27 of the first embodiment.

In the configuration in which the transport path 8 has the U-turn path 15, for example, when a relatively elongated second medium 22 is discharged from the discharge port 10, there is a concern that the second medium 22 may be bent or buckle and fall down forward, or be drawn into the first feed port 61 again.

In the present embodiment, the discharge port 10 is provided with the medium pressing section 60 that restricts the posture of the second medium 22 that was transported through the U-turn path 15 and discharged from the discharge port 10. The medium pressing section 60 includes the base section 62 positioned on the discharge port 10 side and the posture restriction section 63 that extends from the base section 62 to a position above the first feed port 61 along the support surface 12. By this, since the posture of the second medium 22 discharged from the discharge port 10 is restricted in a state along the support surface 12, the posture of the second medium 22 is stabilized without buckling or the like. As a whole, the stackability of the second medium 22 is improved.

In the present embodiment, when the second medium 22 set in the small width medium feeding section 27 is discharged from the discharge port 10 of the discharge section 11, the posture is further restricted by the medium pressing section 60. By this, the posture of second medium 22 is stabilized without buckling or the like. As a whole, the settability and the stackability of the second medium 22 are improved.

(2) In the present embodiment, the first angle θ1 formed by the surface 64 on which the medium pressing section 60 extends and the horizontal surface 65 is smaller than the second angle θ2 formed by the support surface 12 and the horizontal surface 65. That is, the distance between the medium pressing section 60 and the support surface 12 of the support section 13 gradually narrows upward. By this, it is possible to reliably support the second medium 22 to be fed and the second medium 22 to be discharged from the discharge port 10, and it is possible to suppress the medium from being drawn into the first feed port, the occurrence of buckling, or the like.

(3) In the present embodiment, the surface of the medium pressing section 60, which faces the support surface 12, has the rib 66, which protrudes toward the support surface 12. By this, since the second medium 22 to be fed and the second medium 22 to be discharged are restricted to the support surface 12 side by the rib 66, it is possible to further suppress the occurrence of drawing of the second medium 22 into the first feed port 61 or the like, buckling, or the like.

(4) In the present embodiment, the medium pressing section 60 is retractable in a direction away from the first feed port 61. By this, by retracting the medium pressing section 60 from the first feed port 61, it is possible to easily set the first medium 21 in the first feed port 61 or set the second medium 22 in the small width medium feeding section 27.

(5) In the present embodiment, since the medium pressing section 60 has the second attachment section 71, which is attachable to and detachable from the housing 5, it can be easily attached to and detached from the housing 5. That is, the medium pressing section 60 can be attached when necessary and detached when not necessary.

Since the second attachment section 71 has the locking section 73 configured to lock to the locked section 72 provided at the section of the discharge port 10 of the housing 5, attachment and detachment can be realized with a simple structure.

(6) In the present embodiment, the medium pressing section 60 is attached on the housing 5 by the second positioning mechanism 78. By this, it is possible to prevent the position at which the medium pressing section is attached from varying.

### Third Embodiment

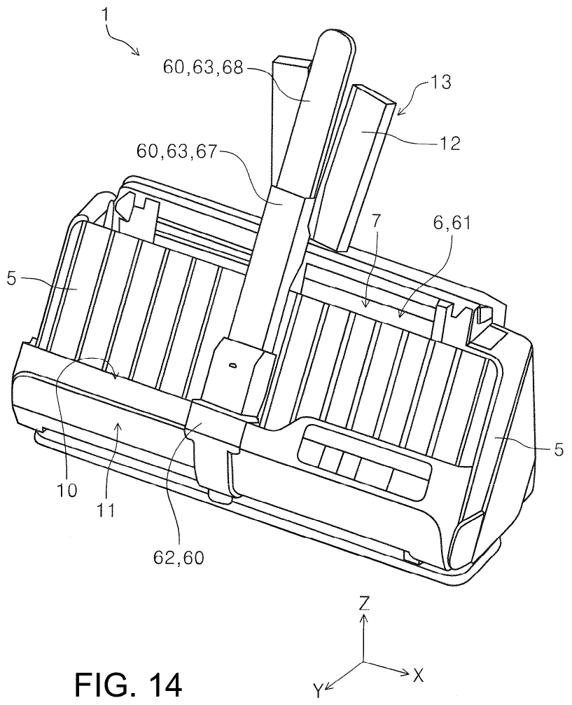

Next, the medium transport device 4 according to a third embodiment and the image reading device 1 including the medium transport device 4 will be described with reference to FIG. 14. The same parts as those in the first embodiment and the second embodiment are denoted by the same reference symbols and the description of the configuration and the corresponding effects thereof will be omitted.

As shown in FIG. 14, the medium transport device 4 of the third embodiment corresponds to a structure in which the small width medium feeding section 27 is removed from the medium transport device 4 of the second embodiment shown in FIG. 1 and only the medium pressing section 60 is provided, and the other structure is the same as that of the second embodiment. Therefore, the description of the structure is omitted.

Since the present embodiment is a structure without the small width medium feeding section 27, it is assumed that amongst the medium 2, the medium to be transported is mainly the first medium 21. However, the second medium 22 may be fed from the first feed port 61 in a state in which the small width medium feeding section 27 is not provided.

In the present embodiment, since the medium pressing section 60 is provided, the posture of the medium 2 discharged from the discharge port 10 is restricted in a state along the support surface 12. By this, the posture of medium 2 is stabilized without buckling or the like. As a whole, the stackability of the medium 2 is improved.

### Other Embodiments

The medium transport device 4 according to the present disclosure and the image reading device 1 including the medium transport device 4 basically have the configurations of the above described embodiments, but it is of course possible to change or omit a partial configuration without departing from the scope of the present disclosure.

In the above described embodiment, a case where a device including the medium transport device 4 is the image reading device 1 such as a scanner has been described. However, the device is not limited to the image reading device, and can also be applied to an image forming device such as a printer.

What is claimed is:

1. A medium transport device comprising:
a feeding section having a first feed port at an upper section of a housing, the first feed port being for feeding a first medium into the housing and
a transport section configured to transport the first medium fed from the feeding section in a transport direction along a transport path, wherein
the feeding section includes a support section extending upward from the first feed port, and has a support surface configured to support the first medium to be fed to the first feed port,
a small width medium feeding section configured to feed a second medium having a smaller width dimension than the first medium, and
the small width medium feeding section is
disposed at the first feed port and includes
a second feed port configured to feed the second medium into the housing and
a guide section configured to guide a width direction edge portion of the second medium.

2. A medium transport device comprising:
a feeding section having a feed port at an upper section of a housing, the feed port being for feeding a medium into the housing;
a transport section configured to transport the medium fed from the feeding section in a transport direction along a transport path; and
a discharge section having a discharge port configured to discharge the medium transported by the transport section to outside of the housing, wherein
the feeding section includes a support section that extends upward from the feed port and that has a support surface configured to support the medium to be fed to the feed port,
the transport path includes a straight path extending from the feed port from an upper portion to a lower portion of the housing, and a U-turn path existing from a downstream end of the straight path in the transport direction toward the discharge port disposed above,
the discharge port is disposed below the feed port of the housing,
the discharge section has a placement surface that is an outer surface of the housing, that extends from the discharge port side toward the feed port, and onto which the medium discharged from the discharge port is placed,
a medium pressing section that is provided in the discharge port and that restricts posture of the medium transported through the U-turn path and discharged from the discharge port, and
the medium pressing section includes
a base section positioned on the discharge port side and
a posture restriction section that extends from the base section to a position above the feed port along the support surface.

3. A medium transport device comprising:
a feeding section having a first feed port at an upper section of a housing, the first feed port being for feeding a first medium into the housing;
a transport section configured to transport the first medium fed from the feeding section in a transport direction along a transport path; and
a discharge section having a discharge port configured to discharge the first medium transported in the transport direction to the outside of the housing, wherein
the feeding section includes a support section that extends upward from the first feed port and that includes a support surface configured to support the first medium to be fed to the first feed port,
the transport path includes a straight path extending from the feed port from an upper portion to a lower portion of the housing, and a U-turn path existing from a downstream end of the straight path in the transport direction toward the discharge port disposed above,
the discharge port is disposed below the first feed port of the housing,
the discharge section has a placement surface that is an outer surface of the housing, that extends from the discharge port side toward the first feed port, and onto which the first medium discharged from the discharge port is placed,
a small width medium feeding section configured to feed a second medium having a smaller width dimension than the first medium,
the small width medium feeding section is
disposed at the first feed port and includes
a second feed port configured to feed the second medium into the housing and
a guide section configured to guide a width direction edge portion of the second medium,
a medium pressing section that is provided in the discharge port and that restricts the posture of the second medium transported through the U-turn path and discharged from the discharge port, and
the medium pressing section includes
a base section positioned on the discharge port side and
a posture restriction section that extends from the base section to a position above the first feed port along the support surface.

4. The medium transport device according to claim 1, wherein
the small width medium feeding section includes
a third feed port configured to feed, into the housing, a third medium with a width dimension in the transport direction smaller than that of the second medium and
a guide section configured to guide a width direction edge portion of the third medium.

5. The medium transport device according to claim 1, wherein
the small width medium feeding section includes a curl correction section configured to correct a curl of the second medium to be fed.

6. The medium transport device according to claim 5, wherein
the small width medium feeding section is positioned upstream of and adjacent to a feed roller pair in the transport direction, the curl correction section includes a projection section that contacts a width direction central portion of a first surface of the second medium,
the small width medium feeding section includes a base surface positioned on the second surface side, which is an opposite side than the first surface of the second medium,
the base surface includes two extension sections that extend in the transport direction at both end portions in the width direction of the second medium,
the two extension sections are positioned to outside in an axial direction of the feed roller pair, and
a tip end of each of the two extension sections partially overlaps with the feed roller pair in the transport direction, and guides a front edge of the second medium toward a nip position of the feed roller pair.

7. The medium transport device according to claim 3, wherein
the small width medium feeding section has a first attachment section configured to attach to and detach from the housing,
the first attachment section has a plate-shaped clip section configured to sandwich an upper edge section of the first feed port and the placement surface, and
a portion of the clip section that is in contact with the placement surface extends from an upper edge section to a lower edge section of the placement surface.

8. The medium transport device according to claim 7, wherein
the small width medium feeding section is positioned and attached to the housing by a first positioning mechanism.

9. The medium transport device according to claim 2, wherein
a first angle formed by a surface on which the medium pressing section extends and a horizontal surface is smaller than a second angle formed by the support surface and the horizontal surface.

10. The medium transport device according to claim 2, wherein
a surface of the medium pressing section that faces the support surface has a rib that protrudes toward the support surface.

11. The medium transport device according to claim 2, wherein
the medium pressing section is retractable in a direction away from the first feed port.

12. The medium transport device according to claim 2, wherein
the medium pressing section has a second attachment section configured to attach to and detach from the housing and
the second attachment section has a locking section configured to lock to a locked section provided at an edge section of the discharge port of the housing.

13. The medium transport device according to claim 12, wherein
the medium pressing section is attached on the housing by a second positioning mechanism.

14. An image reading device comprising:
the medium transport device according to claim 1 and
a reading section configured to read an image of the first medium or the second medium.
